(19) United States
(12) Patent Application Publication
(10) Pub. No.: US 2008/0230696 A1
(43) Pub. Date: Sep. 25, 2008

(54) SURFACE TREATMENT AND SURFACE SCANNING

(75) Inventors: Gerd K. Binnig, Wollerau (CH); Walter Haeberle, Wadenswil (CH); Dorothea W. Wiesmann, Adliswil (CH)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/131,336

(22) Filed: Jun. 2, 2008

Related U.S. Application Data
(63) Continuation of application No. 11/156,839, filed on Jun. 20, 2005.

(30) Foreign Application Priority Data
Jun. 21, 2004 (EP) 04405384.1

(51) Int. Cl. G01N 23/00

(52) U.S. Cl. 250/307; 250/311

(57) ABSTRACT

Provides surface treatment devices, surface scanning devices, methods of operating a surface treatment device and methods of operating a surface scanning device. An area within a medium comprises at least one sharpening location for sharpening a tip of a probe mechanically. The tip is conically shaped with a radius of an apex smaller than 100 nm. In the case of the surface treatment device the probe is designed for altering the surface of the medium. In the case of the surface scanning device the probe is designed for scanning the medium. The sharpening location is suited for sharpening the tip mechanically. For that purpose the probe and the medium are being moved relative to each other such that the tip is located in the sharpening location. Then the probe and/or the medium are moved relative to each other such, that the tip is mechanically sharpened.

### RELATED APPLICATION

This application is a continuation of U.S. application Ser. No. 11/156,839, filed on Jun. 20, 2005.

### FIELD OF THE INVENTION

The present invention relates to a surface treatment device, a surface scanning device, a method for operating a surface treatment device and a method for operating a surface scanning device.

### BACKGROUND OF THE INVENTION

Different concepts for scanning surfaces in particular with a resolution in the nanoscale range, have been proposed. Also concepts for treating surfaces, in particular in the nanoscale range, have been proposed recently.

An example of the concept for surface scanning is a scanning tunneling microscope, which is disclosed in the applicant's U.S. Pat. No. 4,343,993. The scanning tunneling microscope comprises a conductive tip that serves as a scanning electrode. The conductive tip is arranged movably in respect to a conductive sample. During the operation of the scanning tunneling microscope the tip is moved across a surface of the conductive sample in close relationship to the conductive sample. The distance between the surface of the conductive sample and the tip is controlled by controlling a tunneling parameter, for example a tunneling current between the tip and the conductive sample.

From applicant's European patent EP 0 223 918 B1 a further concept for scanning surfaces is known. EP 0 223 918 B1 discloses an atomic force microscope for imaging surfaces with atomic resolution. The atomic force microscope comprises a sample holder designed for moving the sample in xyz-directions in steps in the nanometer range. It further comprises a tunnel system including first and second tunnel electrodes and associated electronics for measuring the distance between said tunnel electrodes and for generating a correction signal in response to deviations of said distance from a predetermined value. The sample holder is arranged opposite a sharp point, which forms a tip, fixed to one end of a spring-like cantilever. The sample holder is approached to an apex of the tip so closely, that the electron clouds of the atoms at the apex of the tip touch the electron clouds on the surface of the sample, which results in interatomic forces. The cantilever has a given stiffness and acts as a spring. Its excursion correlates to the interatomic forces. The cantilever forms or carries the first one of the electrodes of the tunnel system. The second tunnel electrode is movably arranged to face the first tunnel electrode within tunneling distance. The correction signal is applied to the sample holder for maintaining the sample-tip distance constant. The atomic force microscope has the advantage that the sample does not need to have an electrically conductive surface.

A combined surface treatment and surface scanning device is disclosed in “the millipede—more than 1000 tips for future AFM data storage” by P. Vettiger et al., IBM Journal Research Development, volume 44, no. 3, May 2000. The combined surface treatment and surface scanning device as disclosed here is a data storage device with a read and write function based on a mechanical x-/y-scanning of a storage medium with an array of probes each having a tip. The probes scan during the operation assigned fields of the storage medium in parallel. In that way high data rates may be achieved. The storage medium comprises a thin polymethylmetha acrylate (PMMA) layer. The tips are moved across the surface of the polymer layer in a contact mode. The contact mode is achieved by applying small forces to the probes so that the tips of the probes can touch the surface of the storage medium. For that purpose the probes comprise cantilevers which carry the sharp tips on their end sections. Bits are represented by indentations or non-indentations in the polymer layer. The cantilevers respond to these topographic changes in the surface while they are moved across the surface.

Indentations are written on the polymer surface by thermal mechanical recording. This is achieved by heating a respective probe with a current or voltage pulse during the contact mode in a way that the polymer layer is softened locally where the tip touches the polymer layer. The result is a small indentation in the layer having a nanoscale diameter.

Reading is also accomplished by a thermomechanical concept. The heater cantilever is supplied with an amount of electrical energy, which causes the probe to heat up to a temperature that is not high enough to soften the polymer layer as is necessary for writing. The thermal sensing is based on the fact that the thermal conductance between the probe and the storage medium, especially a substrate of the storage medium, changes when the probe is moving in an indentation as the heat transport is in this case more efficient. As a consequence of this the temperature of the cantilever decreases and hence also its resistance decreases. This change of resistance is then measured and serves as the measuring signal.

U.S. Pat. No. 6,452,171 B1 discloses a scanning probe microscope which comprises a probe, that is used for scanning the surface of a sample. The probe comprises a sharp tip in the nanometer range with nanotubes attached to the apex of the tip. The nanotubes consist of carbon. In order to sharpen the nanotube bundle it is proposed to place the tip with the nanotubes in a deepest point of a v-shaped groove of known geometries and spatial separations. Then a voltage in the range of 5 to 20 Volt is applied to shorten the nanotubes. The end form of the nanotube bundle resembles a v-shape with a nanotube protruding from the bundle.

“In Situ sharpening of Atomic Force Microscope Tips”, IBM Technical Disclosure Bulletin, February 1995, Volume 38, Pub. No. 2, pages 637-638, teaches moving a tip of an atomic force microscope on a conductive sample area. An electro-chemical current occurs between the tip and the substrate. Consequently, material from the substrate is deposited onto the tip. The tip is sharpened as the ionic current and hence a deposition of the material is highest at the apex of the tip.

U.S. Pat. No. 5,578,745 discloses calibration standards for a probe microscope. Adjacent shaped grooves are placed in a single crystal etched with great accuracy and known dimensions by a combination of anisotropic and isotropic etching to produce a scanning probe microscope calibration standard with fine v-shaped grooves forming a prismatically shaped ridge or blade between them. A microscope probe to be calibrated is used to profile the tip of the ridge in a number of places along the length of the ridge. With knowledge of the sidewall angles and a tip radius of the calibration standard both the tip dimensions can be calculated from the profile it produces.

All these concepts have in common that their precise operation relies upon defined dimensions of their tips especially on a very small radius of the apex of the tips. However it has been shown that during the operation of the surface treatment or surface scanning devices the tip of their probe may get contaminated or may be subject to wear. This has the consequence that the apex radius increases and that the operation of the respective device becomes less precise. Accordingly, it is a challenge to provide a surface treatment device, a surface scanning device, a method of operating a surface treatment device and a method of operating a surface scanning device which enables a precise and long-lasting operation.

### SUMMARY OF THE INVENTION

According to one aspect of the invention, a surface treatment device is provided, comprising a medium with a surface, at least one probe designed for altering the surface of said medium and comprising a conically-shaped tip with an apex radius smaller than 100 nm. An area within the medium comprises at least one sharpening location for sharpening the tip mechanically. The material of the medium with the surface is not limited. Preferentially it comprises a substrate and a polymer layer which then faces the probe. Also the way the probe alters the surface of the medium is not limited, it may for example alter the medium thermomechanically, thermally or only by mechanical forces. The surface treatment device further comprises a drive for moving the medium and/or the probe relatively to each other.

In an advantageous embodiment the sharpening location comprises a flank with an edge being formed such, that during a movement of the tip in direction towards the flank first a generated surface of the tip is in contact with the edge before the apex contacts the edge. In that way the geometrical properties of the sharpening location are such, that the wear at the generated surface of the tip is larger, when the tip is moved towards the flank so far that also the apex is moved across the edge, than the wear on the apex of the tip. This results in an effective sharpening of the probe.

According to another aspect of the invention, a surface scanning device is provided, comprising a medium with a surface, at least one probe designed for scanning the surface of the medium and comprising a conically-shaped tip with an apex radius smaller than 100 nm, a drive for moving the probe relative to the medium and an area within the medium comprising at least one sharpening location for sharpening the tip mechanically.

In an advantageous embodiment of the surface scanning device the sharpening location comprises a flank with an edge being formed such, that during a movement of the tip in direction towards the flank first the generated surface of said tip is in contact with the edge before the apex contacts the edge. In another advantageous embodiment the flank is formed in a recess of the medium.

According to another aspect of the invention a method is provided for operating a surface treatment device.

According to another aspect of the invention a method is provided for operating a surface scanning device.

In an advantageous embodiment of the methods the sharpening location is a recess in the medium comprising a flank with an edge being formed such, that during a movement of the tip in direction towards the flank first the generated surface of the tip is in contact with the edge before the apex contacts the edge and the edge is formed around the recess and the probe and/or the medium are moved relative to each other across the recess in different directions. In this way a symmetric sharpening of the tip can simply be achieved.

### BRIEF DESCRIPTION OF THE DRAWINGS

The invention and its embodiments will be more fully appreciated by reference to the following detailed description of presently advantageous but nonetheless illustrative embodiments in accordance with the present invention when taken in conjunction with the accompanying drawings, in which:

FIG. 1 shows a perspective view of a storage device,

FIG. 2 shows a top view of a storage medium with a symbolic probe array that forms a part of the storage device according to FIG. 1,

FIG. 3 shows a perspective view of a probe,

FIG. 4 shows a cross-sectional view of the probe according to FIG. 3 and the storage medium,

FIG. 5 shows a first embodiment of a sharpening location in the storage medium,

FIG. 6 shows an enlarged view of a tip of the probe,

FIG. 7 shows another embodiment of the sharpening location in the storage medium,

FIG. 8 shows another embodiment of the sharpening location in the storage medium and

FIG. 9 shows another embodiment of the sharpening location in the storage medium.

Different figures may contain identical references representing elements with similar or uniform content.

### SYMBOLS

1. storage device
2. storage medium
4. substrate
6. polymer layer
8. probe array
10. probe
12. linking element
14. spring cantilever
16. tip
18. apex
20. radius of the apex
22. generated surface
24. heater platform
26. legs
28. indentation mark
30. multiplexer
32. field
34. control unit
36. drive
40. recess
42. flank
44. edge
46. gold strip
48.-50. point (of the tip-forces)
52. elevation

### DETAILED DESCRIPTION OF THE INVENTION

The invention provides a surface treatment device, a surface scanning device, a method of operating a surface treatment device and a method of operating a surface scanning device which enable a precise and long-lasting operation. An example of a surface treatment device, comprises a medium with a surface, at least one probe designed for altering the surface of said medium and comprising a conically-shaped tip with an apex radius smaller than 100 nm. An area within the medium comprises at least one sharpening location for sharpening the tip mechanically. The material of the medium with the surface is not limited. Preferentially it comprises a substrate and a polymer layer which then faces the probe. Also the way the probe alters the surface of the medium is not limited, it may for example alter the medium thermomechanically, thermally or only by mechanical forces. The surface treatment device further comprises a drive for moving the medium and/or the probe relatively to each other.

A main advantage is that the sharpening of the tip can be performed in situ. This is in particular a great advantage, if the environment of the probe is for example vacuum or if the device is formed in a way that there is no possibility of accessing the tips from outside the device without for example destroying the device. In that way over a long lifetime of the device a precise operation can be achieved.

In an advantageous embodiment the sharpening location comprises a flank with an edge being formed such, that during a movement of the tip in direction towards the flank first a generated surface of the tip is in contact with the edge before the apex contacts the edge. In that way the geometrical properties of the sharpening location are such, that the wear at the generated surface of the tip is larger, when the tip is moved towards the flank so far that also the apex is moved across the edge, than the wear on the apex of the tip. This results in an effective sharpening of the probe.

In another advantageous embodiment the flank is formed in a recess of the medium. In that way the surface treatment device is simple to manufacture.

In another advantageous embodiment the flank is formed in an elevation of the surface of the medium. This enables in an easy way to use a different material for the sharpening location than for the rest of the surface of the medium by adding that material for forming the elevation on the medium.

In another advantageous embodiment the edge comprises at least partly of gold. Gold has the property of being well-suited for sharpening the tip as it can be applied in a very clean way and hardly oxidizes.

In another advantageous embodiment the edge comprises at least party of polymer, in yet another advantageous embodiment the edge comprises at least partly of silicon.

In a further advantageous embodiment the medium comprises a silicon substrate and a polymer layer and the edge and at least part of the flank are formed in the polymer layer. In that way the device is simple to manufacture, in addition to that the polymer layer in areas outside of the sharpening location might in that way be used for being profiled, for example indentations might be formed thermomechanically by the tip and might represent binary information.

In another advantageous embodiment the medium comprises a silicon substrate and a polymer layer and the edge is formed in the silicon substrate. This shows the advantage that the sharpening procedure of the tip is very effective due to good sharpening properties of silicon.

The invention also provides a surface scanning device comprising a medium with a surface, at least one probe designed for scanning the surface of the medium and comprising a conically-shaped tip with an apex radius smaller than 100 nm, a drive for moving the probe relative to the medium and an area within the medium comprising at least one sharpening location for sharpening the tip mechanically.

In an advantageous embodiment of the surface scanning device the sharpening location comprises a flank with an edge being formed such, that during a movement of the tip in direction towards the flank first the generated surface of said tip is in contact with the edge before the apex contacts the edge. In another advantageous embodiment the flank is formed in a recess of the medium.

In another advantageous embodiment of the surface scanning device the flank is formed in an elevation of the surface of the medium.

In another advantageous embodiment of the surface scanning device the edge comprises at least partly of gold.

In another advantageous embodiment the edge comprises at least party of polymer, in yet another advantageous embodiment the edge comprises at least partly of silicon.

In another advantageous embodiment of the surface scanning device the medium comprises a silicon substrate and a polymer layer. The edge and at least part of the flank are formed in the polymer layer.

In another advantageous embodiment of the surface scanning device the medium comprises a silicon substrate and a polymer layer. The edge is being formed in the silicon substrate.

Advantages of a surface scanning device and embodiments correspond to the advantages of the surface treatment device and its embodiments.

The invention also provides a method is provided for operating a surface treatment device, the surface treatment device comprising a medium with a surface, at least one probe designed for altering the surface of the medium and comprising a conically-shaped tip with an apex radius smaller than 100 nm, a drive for moving the probe and/or the medium relative to each other. The method comprises the steps of moving the probe and/or the medium relative to each other such that the tip is located in the sharpening location and moving the probe and/or the medium relative to each other such that the tip is mechanically sharpened.

The invention further provides a method for operating a surface scanning device, with the surface scanning device comprising a medium with a surface, at least one probe designed for scanning the surface of the medium and comprising a conically-shaped tip with an apex radius smaller than 100 nm, a drive for moving the probe and/or the medium relative to each other and an area within the medium comprising at least one sharpening location for sharpening the tip mechanically. The method comprises the steps of moving the probe and/or the medium relative to each other such that the tip is located in the sharpening location and moving the probe and/or the medium relative to each other such that the tip is mechanically sharpened. The advantages of the methods correspond to the advantages of the devices described above.

In an advantageous embodiment of the methods the sharpening location is a recess in the medium comprising a flank with an edge being formed such, that during a movement of the tip in direction towards the flank first the generated surface of the tip is in contact with the edge before the apex contacts the edge and the edge is formed around the recess and the probe and/or the medium are moved relative to each other across the recess in different directions.

In that way a symmetric sharpening of the tip can simply be achieved.

In another advantageous embodiment of the methods a sharpening location is a recess in the medium comprising a flank with an edge being formed such, that during a movement of the tip in direction towards the flank first the generated surface of the tip is in contact with the edge before the apex contacts the edge, and the edge is formed around the recess and the probe and/or the medium are moved relative to each other across the recess in cycles.

In another advantageous embodiment of the methods the sharpening location is an elevation in the medium comprising a flank with an edge being formed such, that during a movement of the tip in direction towards the flank first the generated surface of the tip is in contact with the edge before the apex contacts the edge, and the edge is formed around the elevation and the probe and/or the medium are moved relative to each other towards the center of the elevation in different directions. In that way a symmetric sharpening of the tip can simply be achieved.

In a further advantageous embodiment of the methods the sharpening location is an elevation in the medium comprising a flank with an edge being formed such, that during a movement of the tip in direction towards the flank first the generated surface of the tip is in contact with the edge before the apex contacts the edge, and the edge is formed around the elevation and the probe and/or the medium are moved relative to each other in cycles towards the center of the elevation in cycles.

In another advantageous embodiment of the methods the temperature of the tip is controlled to a given value. In that way the given value may be chosen in order to achieve excellent sharpening results as the temperature of the tip has effect on the hardness of the edge when moving across the edge, and as the temperature of the tip has impact on electro-chemical processes that might be involved.

In connection with any one of the different embodiments of the present invention which cover a surface treatment device, a surface scanning devices a method of operating a surface treatment device and a method of operating a surface scanning device, it is further advantageous to provide a tip cleaning step. Such a tip cleaning step preferably comprises one of or both of the following features: (a) heating the tip to a value higher than 300 degrees Celsius; (b) the sharpening location comprising a particle.

With regard to feature (a), the following embodiments can be preferably be applied individually or in combination with each other: The tip is heated to a temperature higher than 450 degrees Celsius. Irrespective of the temperature chosen, the tip is heated to such temperature for a period longer than 1 sec, and in particular longer than 50 sec. The tip is heated regularly in a tip cleaning mode. The tip is not in contact with the medium to be scanned or to be treated during the heating of the tip.

Feature (a) is particularly helpful for removing material picked up by the tip from the medium to be scanned or to be treated and thus preserves the sharpness of the tip. The tip is kept clean and the preciseness of the scanning or treatment device is improved. Adhesion is kept low, i.e. the tip is kept clean, and in case of applying this feature to a local probe storage array a sustained bit writing with a SNR (signal to noise ratio) of about 9 dB is possible.

With regard to feature (b), the following embodiments are advantageous to be applied individually or in combination with each other: The edge introduced in combination with the flank is formed by the particle. The tip is moved across the particle. Such particle can be attached to the medium at an appropriate position. In case of applying this feature to a local probe storage array, such particles can be arranged at each line of indentations—e.g. amongst indentations of such line or at the end or the beginning of such line—such that within each cycle of reading or writing a line of indentations the tip also comes across an associated particle for tip cleaning purposes.

Such arrangement can also be suitable for any of the sharpening locations as introduced above. Such sharpening location might comprise a groove being associated to many different lines of indentations within a storage field of a local probe storage array.

Feature (b) is particularly helpful for removing material picked up by the tip from the medium to be scanned or to be treated and thus preserves the sharpness of the tip. The tip is kept clean and the preciseness of the scanning or treatment device is improved.

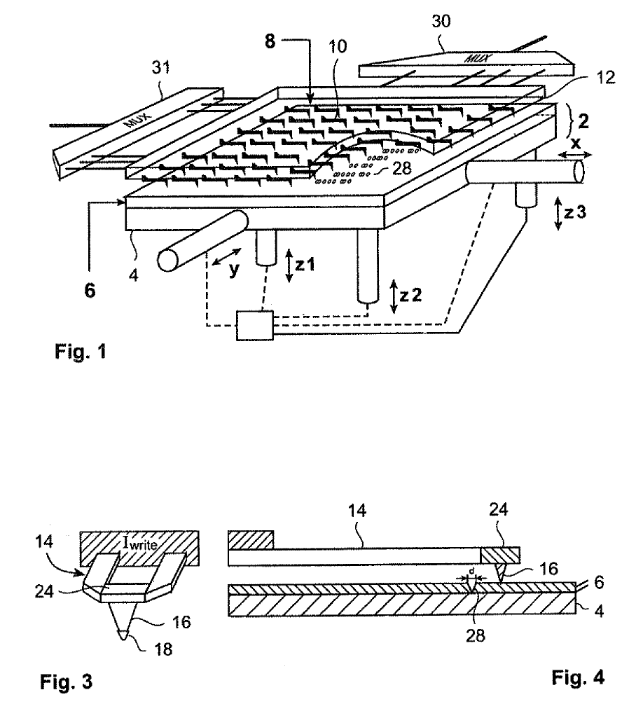

FIG. 1 shows a perspective view of a storage device, that is a surface treatment device and at the same time a surface scanning device. A storage medium 2 comprising a substrate 4 and a polymer layer 6 is facing a probe array 8 having a plurality of probes 10. Probes 10 are mechanically linked to a linking element 12 having the shape of a plate. The linking element 12 is transparent and cut open at one edge solely for demonstration purposes.

FIG. 3 shows a perspective view of a single probe 10. The probe comprises a spring cantilever 14 with a tip 16 at its end. The spring cantilever 14 is sensitive to vertical forces. The stiffness of the spring cantilever 14 in a lateral direction is much higher than in the vertical direction.

The tip 16 is conically-shaped and has a decreasing diameter towards its apex 18. The apex 18 has preferably a radius 20 (FIG. 6) of only a few nanometers. Preferably the radius 20 of the apex 18 is smaller than 100 nm and is preferably around 20 nm or less. Ideally only one atom forms the apex 18 of the tip 16. The tip 16 further comprises a generated surface 22, which might also be called the wall of the tip 16. The apex 18 does not form a part of the generated surface 22.

The probe 10 further comprises a heater platform 24 between legs of the spring cantilever 14 and the tip 16. The spring cantilever 14 is preferably fabricated entirely of silicon for good thermal and mechanical stability. The legs of the spring cantilever 14 are preferably highly doped in order to minimize their electrical resistance as they also serve the purpose of an electrical connection to the heater platform 24, the heater platform has a high electrical resistance of, for example, 11 kilo Ohms.

Indentation marks 28 are written on the storage medium 2 using a thermomechanical technique. A local force is applied to the polymer layer 6 by the probe 10. The polymer layer 6 is softened by heating the heater platform 24 with a current or voltage pulse during the contact mode, so that the polymer layer 6 is softened locally where the tip 16 touches the polymer layer 6. The result is a small indentation mark 28 in the polymer layer (see FIG. 4) having a nanoscale diameter.

The indentation marks 28 represent binary information. For example, an indentation mark may represent a logical “1” and the absence of the indentation mark 28 may represent a logical “0”. However, the indentation mark 28 or an absence of the indentation mark 28 may also represent a different information, for example the presence of the indentation mark 28 may represent a logical “0” and the absence of the indentation mark 28 may represent a logical “1”.

In order to read data, the polymer layer 6 is moved under the probe array 8 at a constant velocity. The scanning velocity and the distance between the indentation marks 28 determine the data rate of the system in indentation marks 28 or bits read or written per second. Reading is also accomplished with a thermomechanical concept. For reading purposes the heater platform 24 is operated at a temperature that is not high enough to soften the polymer layer 6 as is necessary for writing. The thermal sensing is based on the fact that the thermal conductance between the probe 10, in particular the heater platform 24 and the tip 16, and the storage medium 2 changes when the tip 16 is moving into an indentation mark 28 where the distance between the heater platform 24 and the polymer layer 6 is reduced. During a motion of the tip 16 the temperature change of the heater platform 24 is gradual as it moves towards the center of the indentation mark 28, where the indentation mark's 28 depth is maximum. Consequently the resistance of the heater platform 24 decreases at the same time. Thus changes in the resistance of the heater platform 24 may be monitored while the probe 10 is scanned over indentation marks 28.

Solely for demonstration purposes marks 28 are shown only in a confined area of the storage medium 2 back in FIG. 1. In the advantageous embodiment the probes 10 are suited for scanning the entire storage medium 2 either by moving the probe array 8 relatively to a storage medium 2 or vice versa. In FIG. 1 the storage medium 2 is moved while the probe array 8 is fixed in its position. Arrows X and Y indicate the scanning direction, while Z arrows indicate an approaching and leveling scheme in vertical direction for bringing the entire probe array 8 into contact with the storage medium 2. For that purpose the storage device comprises a respective drive 36, the drive 36 comprises respective actuators, for example electromagnetic or piezoelectric actuators by means of which actuation in the different direction is precisely achieved.

The storage medium 2 is divided into fields, not explicitly shown in FIG. 1. Each probe 10 of the probe array 8 writes or reads only in its own data field. Consequently a storage device with, for example 32×32 probes includes 1024 fields.

The storage device is preferentially operated with row and column time-multiplexing addressing, schematically shown by multiplexers 30, 31. The storage device according to FIG. 1 is ready for parallel scanning of all fields. Storage fields might also be scanned row by row or column by column. Every movement of a single probe 10 is applied to all the other probes 10 due to mechanical coupling of the probes 10.

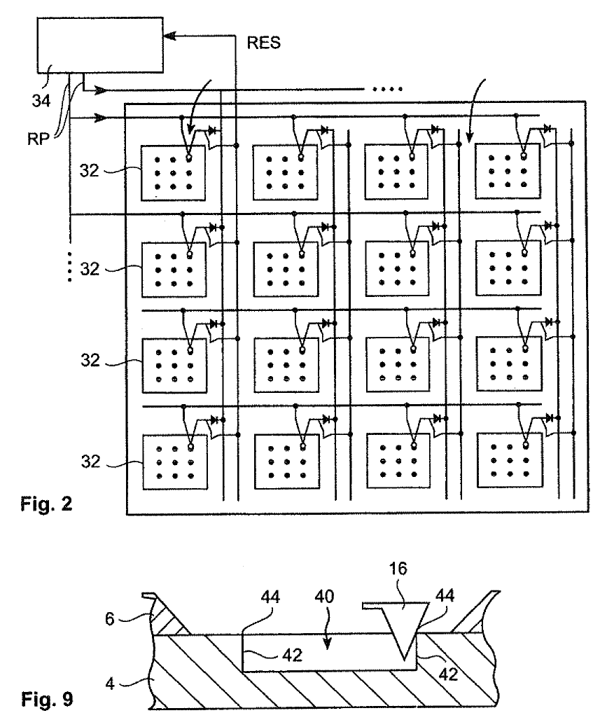

FIG. 2 represents a symbolic top view of the storage medium 2 with 4×4 fields 32 arranged in rows and columns. Each field 32 comprises indentation marks 28. There are symbolic nine indentation marks 28 disclosed within each field 32. This amount is of course not of true nature but only symbolic as it is customary for these kind of storage devices to pack as much data marks on the storage medium 2 as resolution allows. The fields 32 are bordered in order to make them visible. Such borders in forms of grooves might also be placed on the storage medium 2 for defining the beginning and the end of a field 32, but this is not necessarily the case. Rather fields 32 are defined by the extent of indentation marks 28 a single probe 10 is responsible for.

In addition, only a few symbolic probes 10 are shown. The probes 10 are electrically connected with the multiplexers 30, 32, which are preferentially time multiplexers. Their connection with the multiplexers 30, 31 is represented symbolically with common wires in FIG. 2.

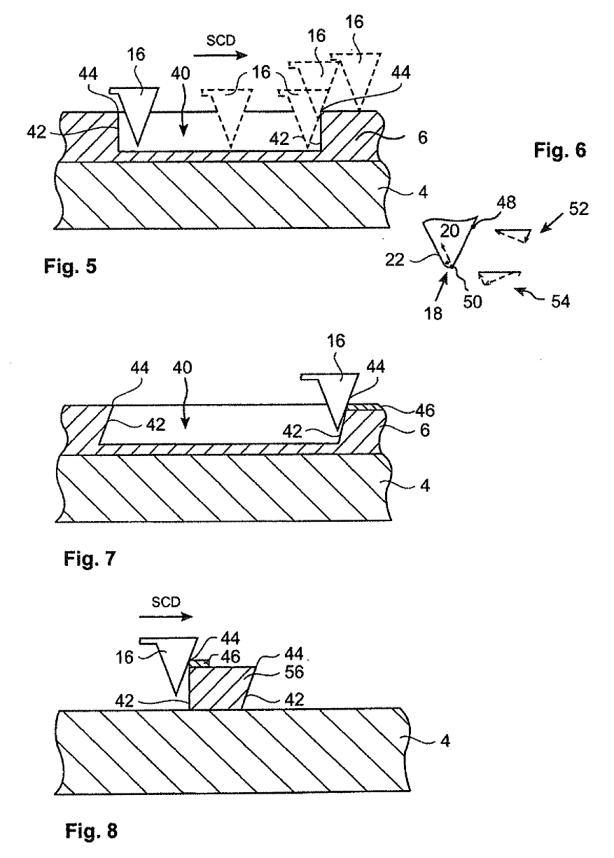

To each of the fields 32 a sharpening location is assigned, which is not explicitly shown in FIG. 1 and FIG. 2 but is explained in the following with the aid of the FIGS. 5 to 9. In an advantageous embodiment the sharpening location is located off-centered in each field 32, preferably in one of the corners of the fields 32. There may also be more than one sharpening location assigned to each field 32 in order to provide for, for example, redundancy. If one of the assigned sharpening locations degrades, then another sharpening location may be used. This can improve the lifetime of the storage device. However, if there are more than one assigned sharpening locations they may also be of another different nature with different sharpening properties. This then enables to select the right sharpening location for the current needed purpose.

In an advantageous embodiment according to FIG. 5 the sharpening location is formed by a recess 40 in the polymer layer 6. The recess 40 has more or less perpendicularly directed walls relative to the surface of the polymer layer 6. These walls are called flanks 42 in the following. An edge 44 is formed on one of the ends of each flank 42. It is the upper end according to FIG. 5. A tip 16 of a probe 10 is moved across the recess in a scanning direction SCD shown by an arrow. Each flank 42 with the edge 44 is formed such, that during a movement of the tip 16 in direction towards the flank 42 first the generated surface 22 of the tip 16 contacts the edge 44 before the apex 18 of the tip 16 contacts the edge. As the spring cantilever 14 of the probe pretensions the tip 16 towards the surface of the polymer layer 6, the tip 16 protrudes into the recess 40 while it is moved across the recess 40. When the generated surface 22 of the tip 16 gets in contact with the edge 44, for example, at a point 48, a resulting force between the tip 16 and the edge 44 of polymer layer 6, which is shown by the vectors 52 has a strong component in a perpendicular direction towards the generated surface 22. In addition to that the force between the tip 16 and the polymer layer is relatively strong due to the high stiffness of the spring cantilever 14 in a lateral direction and due to a high torsional stiffness. This perpendicular force causes wear on the generated surface 22, which might also be called side-wall of the tip 16.

When the tip 16 is moved further in the scanning direction SCD, the tip 16 moves up and in that way the edge 44 grinds the generated surface 22 of the tip. When the tip 16 contacts the edge 44 in the area of its apex 18, shown by example for a point 50, the forces acting in the perpendicular direction on the apex are much lower than the respective perpendicular forces on the generated surface as shown by example on the point 48. The resulting force of the vectors are shown by example for the point 50 of the apex 18 with the respective force vectors being shown by 54. The perpendicular component of the force acting on the apex 18 is very low, because the spring cantilever 14 is much more flexible in a direction perpendicular to the scanning direction SCD than in the scanning direction SCD. In that way more material is grinded away from the generated surface 22 than from the apex 18 which results in sharpening of the tip 16.

In the advantageous embodiment the recess 40 has a circular shape. By moving the tip 16 in different directions across the recess 40 the tip may be sharpened symmetrically. However the recess 40 may also have a different shape from a circular shape, for example an elliptical or rectangular shape. The tip 16 may also be moved around the recess 40 in a circular way preferably with its distance from the center of the recess 40 gradually increasing. In that way very good sharpening results of the tip may be achieved in a fairly symmetric way.

By controlling the temperature of the tip 16 to a given value, which may be accomplished by respectively heating the heater platform 24, the accuracy of the sharpening process may even be enhanced.

FIG. 7 shows another embodiment of the sharpening location. In this case the sharpening location is also formed as the recess 40. In this embodiment it is shown by example that the flanks 42 may also have an angle relative to the regular surface of the polymer layer 6 other than a perpendicular angle. The angle of the flank 42 has however always to be chosen in a way, that during a movement of the tip 16 in direction towards each flank 42 first the generated surface 22 of the tip 16 is in contact with the edge 44 before the apex 18 contacts the edge 44.

One of the edges 44 shown in FIG. 7 comprises at least partly of gold. For that purpose a gold strip 46 or gold layer is brought onto the polymer layer 6. In that way the amount of wear on the generated surface 22 of the tip 16 may even be increased in respect to when the edge is not covered with gold. The recess 40 may comprise flanks 42 with different angles but it may also comprise flanks with only the same angle. In addition to that the gold strip 42 may just cover the edge 42 in part of the recess or around the recess 40.

According to another embodiment (FIG. 8) the sharpening location is an elevation 56. In this case the elevation 56 is for example located on top of the substrate 4. It may however also be located on top of the polymer layer 6. The elevation 56 has respective flanks 42 with respective edges 44 formed on one of the ends, especially the upper end, of each flank 42. The edges 44 might also in this case comprise at least partly of gold especially by having a gold strip 46 located on top of the elevation 56, or might comprise silicon or polymer material. The sharpening procedure works respectively as described above for the other embodiments. The sharpening takes place, when the tip 16 is moved in the scanning direction SCD towards the center of the elevation and the edge 44 contacts the tip 16. For receiving a symmetrically sharpened tip 16 the tip 16 may be moved in different directions towards the center of the elevation 56 or may be moved in circles around the elevation 56 gradually approaching the center of the elevation 56.

FIG. 9 shows another embodiment of the sharpening location. In this embodiment the sharpening location is also formed as the recess 40 in this case in the substrate 4, which is preferentially a silicon layer. In this embodiment the flanks 42 and the edges 44 are formed in the substrate 4. In addition to that edges and respective flanks may also be formed in the polymer layer 6 for an additional grinding but this is not necessarily the case.

For all different shapes of sharpening locations the edge might also comprise electrically conductive material. Such material can be gold, for example. An electric current can be applied to such conductive material for controlling electro-chemical processes when the tip moves across the edge. Typically, a film of water is present when supporting the sharpening process by an electro-chemical process. Such effect is described in the article published in the IBM Technical Dislcosure Bulletin which is referenced above and incorporated by reference herewith.

The described embodiments of the sharpening location are not limited to a storage device, which is a combined surface treatment and surface scanning device. They may also be part of a surface treatment device of another kind, which enables for example to make lithography in a nanoscale range. They may also be part of another surface scanning device such as a scanning tunneling microscope which is disclosed in U.S. Pat. No. 4,343,993, which is incorporated for this purpose by reference herein. It may also be a part of an atomic force microscope which is disclosed in U.S. Pat. No. 5,347,854, which is also incorporated by reference herein. The recess according to the embodiments of FIGS. 5, 7 and 9 need not necessarily be formed in the polymer layer 6 or the substrate 4, they may also be formed in another layer which is suitable for that purpose. The same applies respectively for the elevation 56.

What is claimed, is:

1. A surface treatment device comprising
a medium with a surface,
at least one probe designed for altering the surface of said medium and comprising a conically-shaped tip with a radius of an apex smaller than 100 nm,
a drive for moving said medium and said probe relatively to each other,
an area within said medium comprising at least one sharpening location for sharpening said tip mechanically.

2. A device according to claim 1, wherein said sharpening location comprises a flank with an edge being formed such, that during a movement of said tip in direction towards said flank, first a generated surface of said tip is in contact with said edge before said apex contacts said edge.

3. A device according to claim 2, wherein the said flank is formed in a recess of said medium.

4. A device according to claim 3, wherein said flank is formed in an elevation of the surface of said medium.

5. A device according to claim 2, wherein said edge comprises at least partly of gold.

6. A device according to claim 2, wherein said medium comprises a silicon substrate and a polymer layer and wherein said edge and at least part of said flank are formed in said polymer layer.

7. A device according to claim 2, wherein said medium comprises a silicon substrate and a polymer layer and wherein said edge is formed in said silicon substrate.

8. A surface scanning device, comprising:
a medium with a surface,
at least one probe designed for scanning said surface of said medium and comprising a conically-shaped tip with a radius of an apex smaller than 100 nm,
a drive for moving said medium and said at least one probe relatively to each other, and
an area within said medium comprising at least one sharpening location for sharpening said tip mechanically.

9. A device according to claim 8, wherein said sharpening location comprises a flank with an edge being formed such, that during a movement of said tip in direction towards said flank, first a generated surface of said tip is in contact with said edge before said apex contacts said edge.

10. A device according to claim 9, wherein the said flank is formed in a recess of said medium.

11. A device according to claim 10, wherein said flank is formed in an elevation of the surface of said medium.

12. A device according to claim 9, wherein said edge comprises at least partly of gold.

13. A device according to claim 9, wherein said medium comprises a silicon substrate and a polymer layer and wherein said edge and at least part of said flank are formed in said polymer layer.

14. A device according to claim 9, wherein said medium comprises a silicon substrate and a polymer layer and wherein said edge is formed in said silicon substrate.

15. A method for operating surface treatment device, said surface treatment device comprising:
a medium with a surface,
at least one probe designed for altering the surface of said medium and comprising a conically-shaped tip with a radius of an apex smaller than 100 nm,
a drive for moving said medium and/or said at least one probe relatively to each other,
an area within said medium comprising at least one sharpening location for sharpening said tip mechanically,
said method comprising the steps of
moving said at least one probe and said medium relative to each other such that said tip is located in said sharpening location, and
moving said at least one probe and said medium relative to each other such that said tip is mechanically sharpened.

16. A method according to claim 15, wherein said sharpening location is a recess in said medium comprising a flank with an edge being formed such, that during a movement of said tip in direction towards said flank, first a generated surface of said tip is in contact with said edge before said apex contacts said edge and wherein said edge is formed around said recess and wherein said at least one probe and said medium are moved relative to each other across said recess in different directions.

17. A method according to claim 15, wherein said sharpening location is a recess in said medium comprising a flank with an edge being formed such, that during a movement of said tip in direction towards said flank, first a generated surface of said tip is in contact with said edge before said apex contacts said edge, and wherein said edge is formed around said recess and wherein said at least one probe and said medium are moved relative to each other across said recess in cycles.

18. A method according to claim 15, wherein said sharpening location is an elevation in said medium comprising a flank with an edge being formed such, that during a movement of said tip in direction towards said flank, first a generated surface of said tip is in contact with said edge before said apex contacts said edge, and said edge is formed around said elevation and wherein said at least one probe and said medium are moved relative to each other towards the center of said elevation in different directions.

19. A method according to claim 15, wherein said sharpening location is an elevation in said medium comprising a flank with an edge being formed such, that during a movement of said tip in direction towards said flank, first a generated surface of said tip is in contact with said edge before said apex contacts said edge, and said edge is formed around said elevation and wherein said at least one probe and said medium are moved relative to each other in cycles around the elevation towards the center of the elevation.

20. A method according to claim 15, wherein the temperature of said tip is controlled to a given value.

21. A method for operating surface scanning device, said surface scanning device comprising:
a medium with a surface,
at least one probe designed for scanning the surface of said medium and comprising a conically-shaped tip with a radius of an apex smaller than 100 nm,
a drive for moving said medium and/or said at least one probe relatively to each other,
an area within said medium comprising at least one sharpening location for sharpening said tip mechanically,
said method comprising the steps of
moving said at least one probe and said medium relative to each other such that said tip is located in said sharpening location, and
moving said at least one probe and said medium relative to each other such that said tip is mechanically sharpened.

22. A method according to claim 21, wherein said sharpening location is a recess in said medium comprising a flank with an edge being formed such, that during a movement of said tip in direction towards said flank, first a generated surface of said tip is in contact with said edge before said apex contacts said edge, and wherein said edge is formed around said recess and wherein said at least one probe and said medium are moved relative to each other across said recess in different directions.

23. A method according to claim 21, wherein said sharpening location is a recess in said medium comprising a flank with an edge being formed such, that during a movement of said tip in direction towards said flank, first a generated surface of said tip is in contact with said edge before said apex contacts said edge, and wherein said edge is formed around said recess and wherein said at least one probe and said medium are moved relative to each other across said recess in cycles.

24. A method according to claim 21, wherein said sharpening location is an elevation in said medium comprising a flank with an edge being formed such, that during a movement of said tip in direction towards said flank, first a generated surface of said tip is in contact with said edge before said apex contacts said edge, and said edge is formed around said elevation and wherein said at least one probe and said medium are moved relative to each other towards the center of said elevation in different directions.

25. A method according to claim 21, wherein said sharpening location is an elevation in said medium comprising a flank with an edge being formed such, that during a movement of said tip in direction towards said flank, first a generated surface of said tip is in contact with said edge before said apex contacts said edge, and said edge is formed around said elevation and wherein said at least one probe and said medium are moved relative to each other in cycles around the elevation towards the center of the elevation.

26. A method according to claim 21, wherein the temperature of said tip is controlled to a given value.

27. A device according to claim 8, wherein:
said sharpening location comprises a flank with an edge being formed such, that during a movement of said tip in direction towards said flank, first a generated surface of said tip is in contact with said edge before said apex contacts said edge;
the said flank is formed in a recess of said medium;
said flank is formed in an elevation of the surface of said medium;
said edge comprises at least partly of gold;
said medium comprises a silicon substrate and a polymer layer and wherein said edge and at least part of said flank are formed in said polymer layer; and
said medium comprises a silicon substrate and a polymer layer and wherein said edge is formed in said silicon substrate.
